(19) United States
(12) Patent Application Publication
(10) Pub. No.: US 2014/0218242 A1
(43) Pub. Date: Aug. 7, 2014

(54) COMPUTERIZED NANO-SATELLITE PLATFORM FOR LARGE OCEAN VESSEL TRACKING

(71) Applicant: NanoSatisfi Inc., San Francisco, CA (US)

(72) Inventor: Peter PLATZER, San Francisco, CA (US)

(73) Assignee: NanoSatisfi Inc., San Francisco, CA (US)

(21) Appl. No.: 13/961,875

(22) Filed: Aug. 7, 2013

Related U.S. Application Data
(63) Continuation-in-part of application No. 13/757,062, filed on Feb. 1, 2013.

(51) Int. Cl. G01S 5/02

(52) U.S. Cl. CPC G01S 5/0294
USPC 342/454

(57) ABSTRACT

A tracking system employs a constellation of low earth orbit satellites to receive multiple vehicle tracking signals and based thereon, track within a system grid each vehicle under surveillance. The system can use AIS for ocean going vessels, ADS-B for aircraft, and AEI for trains. Use of the system permits extended tracking of key cargos and the protection of vehicles from piracy and the like.

### CROSS REFERENCE TO RELATED PATENT APPLICATIONS

The present application is a continuation-in-part of U.S. patent application Ser. No. 13/757,062 to Peter Platzer, the inventor here, entitled, “SYSTEM AND METHOD FOR WIDESPREAD LOW COST ORBITAL SATELLITE ACCESS” and filed on Feb. 1, 2013. Another continuation-in-part application by the same inventor is filed concurrently herewith, entitled, “SYSTEM AND METHOD FOR HIGH-RESOLUTION RADIO OCCULTATION MEASUREMENT THROUGH THE ATMOSPHERE.” The contents of both of these applications are incorporated by reference herein.

### FIELD OF INVENTION

The present invention relates to the tracking of ocean/sea traversing vessels and in particular to a computer-controlled platform that permits enhanced tracking of larger ocean-based transport vessels including cargo ships, luxury liners and smaller ships including ocean sail powered vehicles, cruisers and military watercraft. In addition, the present invention can be adapted to track aircraft, or other moving vehicles, using transponder signals or similar.

### BACKGROUND

For centuries, ocean transport has represented a substantial portion of economic activity and a major trade conduit. Throughout its history, sea-based transport and commerce has suffered from the inability to accurately track shipments and vessels involved in transport. Even today, with a world comprised of substantial real-time tracking of nearly every aspect of our world economy, ocean transport remains stubbornly difficult to track for substantial portions of vessel time and journey. This creates significant issues due to the dangerous cargos in transit, the illegal contraband, including human captives, and the use and/or exposure to global terrorism and abuse. A continuing problem with pirates further exposes ocean transport to dangerous threats in certain regions of the world.

Today, most large vessels include automatic beacons that periodically broadcast/announce certain information about each vessel using select frequencies. Known as the Automatic Identification System (AIS), its use was mandated under the United Nations SOLAS convention for all international vessels over 300 tons, cargo vessels over 500 tons and passenger ships of all sizes. The AIS system was originally implemented for communication of critical information about ships navigating coastal waters. The information is used by coastal authorities to coordinate, manage and track maritime traffic near the coast.

AIS transceivers are installed onboard selected vessels and are programmed to automatically broadcast a message containing data on a ship's identity, speed, heading and navigational status every 2-10 seconds. The AIS transceivers broadcast the message in the VHF band, but because they were implemented for the purposes of ship to shore communications, their range is typically limited, and in some instances limited to about 74 km.

While not intended for space based tracking, several proposals have been made that would employ satellite receivers to collect AIS transmissions for tracking purposes. See in particular, Hoye et al., “Spaced based AIS for global maritime traffic monitoring,” Acta Astronautica (2008) 62, 240-245, the contents are hereby incorporated as if restated in full. The foregoing reference offers some suggested alterations to a spaced based receiver for AIS tracking (S-AIS), but does not address all of the current issues in developing consistent tracking using AIS alone. S-AIS takes advantage of the 1000 km vertical range of ship-borne AIS transmissions, well within range of a satellite in low earth orbit. Moving the AIS receivers to a satellite platform allows observational coverage over a much larger area as compared to land- or sea-based receiver stations.

The wide field of view and high coverage also presents the problem of collision between AIS messages. AIS transceivers on each ship shares the same broadcast frequency with transceivers on other ships within the same broadcast area using a form of Self-Organized Time-Division Multiple-Access (SOTDMA). The time divisions are split and reserved by ships within an organized area. The organized area coincides with the ship-to-ship broadcast range of the AIS transceivers (approx. 20 nautical mile radius). S-AIS, however, is capable of detecting AIS signals emanating from multiple “organized areas”, resulting in collisions between time divisions in adjacent areas.

It is possible to increase the probability of detection by a single satellite by limiting the receiver satellite's field of view and/or increasing the observation time over a given area. However, limiting the field of view cripples one of the primary advantages of space based AIS observation—broad observation capabilities. It also would increase the time required for a receiver satellite to observe an area since it must perform more scans to cover an area that would require fewer scans with a larger field of view. Increasing the observation time to parse out the AIS signals has the same effect, because a satellite can only be tasked with observing one area at a time. Introducing these delays early on in the data gathering process could result in further and possibly critical delays in the response system.

### SUMMARY

An object of the present invention is to provide a large constellation of small satellites each equipped with a selectively tuned or adjustable receiver capable of capturing AIS or similar signals for use in tracking and monitoring ship movements.

Another object of the present invention is to provide a large constellation of small satellites that communicate with one or more ground base stations to provide network-based support and access to ship movements as determined by the satellites.

It is a further object of the present invention to provide a plurality of satellites orbiting the earth to capture AIS signals from ocean traversing vessels so that these vessels can be continuously monitored during transit.

Yet another object of the present invention is to provide a constellation of satellites in low earth orbit, positioned to receive identifying signals from one or more aircraft for purposes of tracking and monitoring aircraft movement. In a particular example, the United States will soon require the majority of aircraft operating within its airspace to be equipped with some form of Automatic Dependent Surveillance-Broadcast (ADS-B) technology. The US ADS-B requirement is currently slated to come into effect by Jan. 1, 2020. In the EU airspace, planes with a weight above 5,700 kilograms (13,000 lb) or a maximum cruising speed of over 250 knots will be required to carry ADS-B and is currently slated to phase in between 2015 and 2017.

Still a further object of the present invention is to provide a constellation of satellites with the capability of capturing images of ships, airplanes or other vehicles and their movements and to process these images in conjunction with signals collected from the moving vehicles to enhance overall tracking of a large volume of vehicles by the space based tracking satellites.

It is a further object of the present invention to provide a network of ground based stations that track multiple satellites and collect data from the satellites relating to images and ship and airplane identification signals.

It is another object of the present invention to provide a constellation of satellites equipped to receive AIS signals and to capture images of select regions of ocean and to integrally process associated data to discern pirate and/or disabled ship locations.

It is another object of the present invention to provide a flexible, satellite-based monitoring platform that can adapt to changing needs and exploit performance gains in receiver and camera technology.

The above and other objects of the present invention are realized in an illustrative embodiment that operates with a deployed network of satellites configured to communicate with one or more ground stations. Individual satellites are positioned in low earth orbits of 200-1000 km above the surface and complete their orbits in approximately 90 minutes. Typically, the satellites in the network will each include memory and processors for implementing programming on-board. One or more satellites in the network are equipped with an optical camera and a receiver for detecting radio transmissions from the ocean vessels and/or aircraft. In some embodiments, more than one receiver will reside on the satellite; in some embodiments, the satellite is stabilized in orientation, but may be re-positioned based on internally generated computer commands or ground-based instructions.

Operation is enhanced by increasing the number of satellites in the network and/or by increasing the number of ground stations in communication with the network. In some embodiments, data will be routed between satellites before transmission is made to one or more ground stations; in some embodiments, a packet communication protocol, similar to well-known FTP protocols for file transfers, may be used so that multiple ground stations sequentially or concurrently can communicate with one or more satellites in the network. Communication between satellites allows for the transfer of data from satellites to ground stations that are either out of range or outside the line of sight of the satellite.

### FIGURES OF DRAWINGS

This invention is described with particularity in the appended claims. The above and further aspects of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

The drawing figures depict one or more implementations in accord with the present teachings, by way of example only, not by way of limitation. In the figures, like reference numerals refer to the same or similar elements.

FIG. 1 illustrates components of the present system.

FIG. 2 depicts a constellation of earth satellites in low altitude orbits.

FIG. 3 depicts a network of ground stations for use with multiple satellites.

FIG. 4 is a representative grid depicting 8 ships with AIS; one without AIS.

FIG. 5 is a flow chart diagram of the programming logic for the present system.

FIG. 6 is a flow chart diagram of more programming logic for the present system.

### DETAILED DESCRIPTION

### Satellite Constellation and Ground Station Network

A constellation of satellites as described in U.S. patent application Ser. No. 13/757,062 (“'62 application”) are launched into a low earth orbit at an altitude of 200-1000 km. Typically, the satellites in the constellation will each include memory and processors for implementing programming on-board. In a preferred embodiment, the satellite platform incorporates standard designs and utilizes commonly available hardware and open source software to realize further cost savings. This allows for a large number of satellites to be produced and launched.

The constellation satellites may include one or more on-board digital camera systems. In a preferred embodiment, one or more constellation satellites are equipped with a high definition digital camera or similar system to capture images within the visible spectrum. In another embodiment, one or more constellation satellites are equipped with a multispectral or hyperspectral digital camera system to capture images over a wide range of the electromagnetic spectrum. In another embodiment, one or more constellation satellites are equipped with a narrow spectrum camera system optimized for capturing images from a task-optimized spectrum band. For example, an IR camera could capture images through the upper cloud layer and detect heat signatures emanating from a ship, which could enhance the ship detection capabilities as described below. The high replacement rate of the constellation satellite system allows for future advances and cost reductions in camera sensors to be exploited.

Each satellite within the constellation in the present invention (“constellation satellite”) is equipped with receiver hardware capable of receiving signals from one or more GNSS systems. In a preferred embodiment the receiver hardware is designed for a particular GNSS system for higher computational efficiency and lower power consumption. In another embodiment, a software GNSS receiver provides the satellite with adaptive signal processing capabilities at the cost of higher processing and power consumption.

One or more constellation satellite is capable of detecting AIS signals. Either a dedicate AIS signal sensor and processor is utilized, or a software defined radio (SDR) system that is configurable to receive and process AIS signals is installed. In a preferred embodiment, a high-gain or other type of directional antenna is used by one or more constellation satellites for detecting AIS signals for higher sensitivity and to provide control over the observed area. A phased array configuration, which utilizes smaller antennas installed on multiple satellites, may be used for further directional control of the observed area and even higher signal gains. Phased arrays, when capable of beam forming, provide the further benefit of allowing directional control over the observed area without the need for physically orienting the satellite platform. In another embodiment, a low-gain antenna is used by one or more constellation satellites to detect AIS signals over a larger observable area. In yet another embodiment, a combination of high-gain and low-gain antennas are used in concert to provide a broad view of detected AIS signals and to lock on to a specific AIS signal or group of AIS signals.

Each additional satellite in the constellation increases temporal resolution and coverage of the system as a whole, and provides more opportunity for intersatellite communication and the benefits it provides as described below. It is preferred to use 10 or more satellites for supporting global ship based tracking and monitoring. It is preferred to use 50-100 satellites in the network—forming a constellation of receivers—for increasing reliability and performance of the network. While fewer than 10 satellites may be deployed in accordance with the present invention, time windows between tracking events will range between 2-6 hrs. For a network of 50 satellites the temporal range for monitoring select regions of ocean comprising shipping traffic drops to 2-10 minutes.

The constellation satellites are capable of attitude control through a combination of magnetorquers and/or reaction wheels. Orientation may be determined through a combination of one or more on-board magnetometers, sun sensors, gyroscopes and/or accelerometers. The constellation satellites are further configured to determine its location and velocity with respect to the Earth through the on-board GNSS receiver. In a preferred embodiment, a satellite's orientation control is used to direct one or more of the on-board sensors towards an area of interest. In another embodiment, the orientation capabilities are used to orient the satellite's on-board communication antennas for optimal transmission.

The constellation satellites are configured to transmit data and communicate with other satellites in the constellation as well as with ground stations. In a preferred embodiment, a telecommunications link between constellation satellites and ground stations is established on one or more UHF and/or SHF radio bands. In another embodiment, the constellation satellites are equipped with software defined radio (SDR) communication systems that allow for telecommunication links to be established through a wide spectrum of radio frequencies and provide the system with the flexibility to adjust according to mission needs.

In a preferred embodiment, data is transferred between constellation satellites and ground stations digitally according to well-known network protocols, such as the File Transfer Protocol (FTP), or a similar system. In other embodiments, the network protocol utilized is secured using a standard such as SSL/TLS, or another similar security standard.

The constellation satellites and ground stations are configured such that intersatellite and satellite to ground station communications are compensated for any Doppler shift in the transmitted signals due to relative velocities. Doppler compensation techniques are well known in the digital communications arts. In a preferred embodiment, phase-locked loop (PLL) and/or frequency-locked loop demodulation algorithms are applied by the receiver to compensate for Doppler shifts.

The intersatellite communications capability allows for the satellite constellation to form an ad hoc wireless data network with each satellite acting as a node and the network formed in a variety of topologies for the transmission of data according to the needs of the mission and the distribution of the satellites. Each constellation satellite may be programmed and configured to link to other constellation satellites within range and forward data sent by those satellites. The topology and data routing can then be determined dynamically according to the connectivity and operational status of the satellite-nodes.

This flexible data routing provides the invention with the advantage of near real-time communications with the ground based network. For example, because a link between any constellation satellite and the ground requires line of sight, there may be times when an individual satellite is not within communications range of a ground station and cannot transmit its data payload. The constellation satellite must then wait until the next ground station comes within range to send its payload. These individual delays can accumulate to unacceptable levels across the network. The present system allows for the out-of-range constellation satellite to send its data payload to the ground network via any other connected constellation satellite.

The large number of satellites in the constellation and flexible network capabilities provides the system with many advantages over current systems. The malfunction of individual satellite-nodes in a large constellation would have a negligible effect on the overall network throughput. Similarly, the satellite network could route around any non-operational ground station. As discussed above, the dynamic routing capability also allows for near real time transmission of acquired data to the ground network.

The ground station network is configured to transmit data to one or more servers (“ground servers”) through the Internet or other suitable data transmission system. For example, a ground station may be connected to the same local area network as a ground server, in which case a more suitable transmission method would be through the local area network.

### AIS Signal Reception

Ship-borne AIS signals are broadcast over the same VHF channel using a TDMA technique that takes advantage of the limited horizontal range of AIS transmitters. Time slots are divided between ships within an organized area. As conventionally used, interference between ships transmitting from adjacent areas on the same time slot is not an issue because the standard horizontal range of the AIS signal does not reach beyond the range of the organized area.

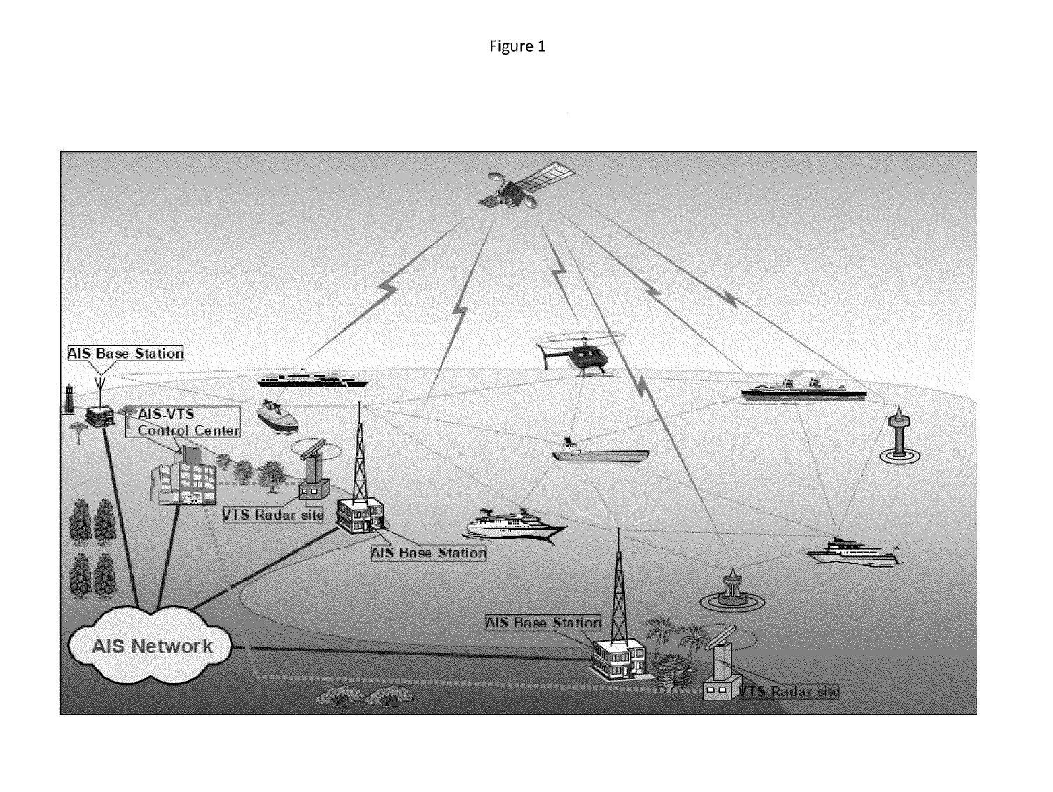

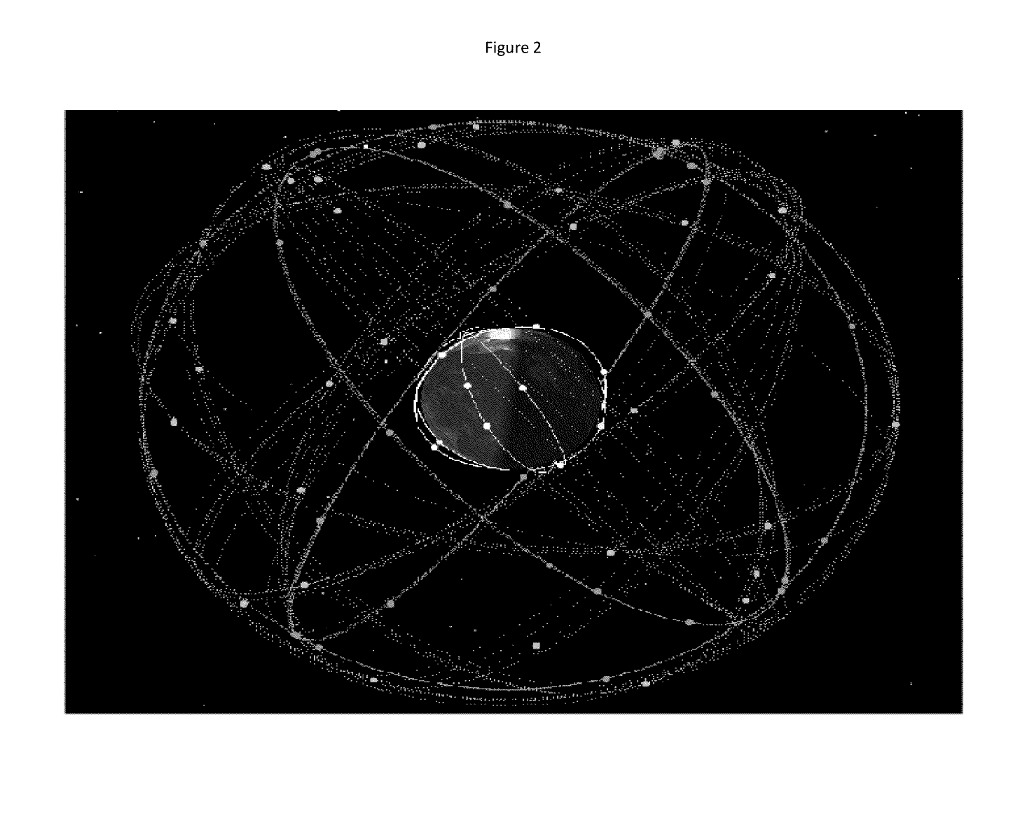

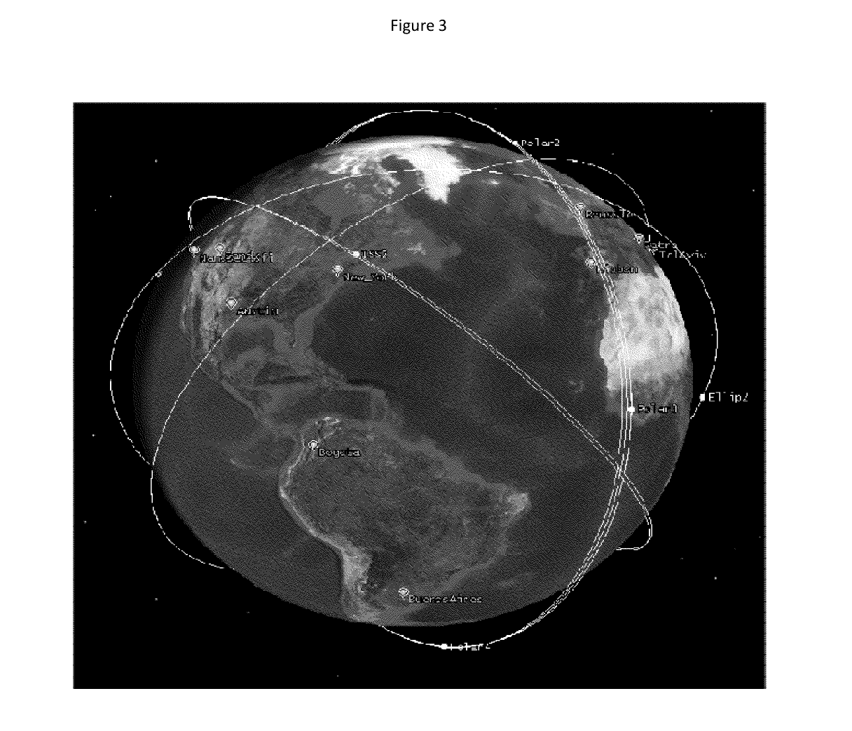

FIG. 1 illustrates an example of the system using a single satellite. FIGS. 2 and 3 illustrate the constellation satellites and their ground stations. The example of FIG. 1 is “multiplied” over the many satellites and additional functionality can be realized using the constellation. FIG. 1 illustrates a satellite receiving AIS signals from both ships and stationary navigational markers. Further illustrated are the standard AIS receiving ground stations. However, as discussed herein, the present examples can operate far from shore in international waters. Using the constellation satellites, large sections of the Earth's navigable waters can be efficiently monitored. FIG. 1 also illustrates the monitoring of aircraft, and that example is discussed below.

For space-based AIS observation, an AIS receiver covers a much larger area than the AIS signal structure was designed to operate within. A standard AIS receiver operating on an orbiting satellite platform can receive competing AIS signals from many organized areas within its field of view. AIS signals operating on the same TDMA time slot, but from different areas can interfere with each other when received by the receiver and reduce the likelihood that either signal can be successfully detected and tracked. Any increase in the number of ships in the observed area further reduces this probability. At an altitude of 1000 km, with an operating field of view to the horizon (˜3630 nautical mile sweep), a standard AIS receiver may receive up to 6200 ship signals simultaneously.

In a further example, the constellation satellites can be placed in much lower orbits, below the 1000 km altitude. At an altitude of 500 km, for example, the satellites only cover ¼ of the area covered by the same satellites at a 1000 km. This should result in only ¼ off the ships in the observed area, or up to 1550 ship signals. This aids in speeding up the processing for the de-collision of the signals. A second benefit to a lower orbit, is that the constellation satellites are automatically de-orbiting within a few years of launch (i.e. falling out of the sky and burning up in the atmosphere). This allows for easy replacement and upgrade cycles, for example, as one satellite de-orbits, another can take its place and not compete for the outdated satellite in its orbital path.

If a large number of AIS sensors are utilized to cover an area, it is possible to increase the probability of detection by limiting each receiver satellite's field of view, but still provide high coverage and data updates. This overcomes the shortcomings of previous attempts at an S-AIS system. The large constellation of satellites described in the '062 application provide an optimal platform for a high coverage S-AIS system that is frequently updated at near real time rates. By limited the field of view of the AIS antenna for each constellation satellite, the number of TDMA organized areas observed by the AIS sensor is controlled. In one embodiment, the field of view is controlled by adjusting the antenna reception characteristics. This may be accomplished by selecting an antenna with the desired reception profile or, in the case of a phased array, shaping the reception beam. In another embodiment, the field of view is controlled by reorienting the satellite.

The use of a constellation of satellites that are properly programmed provides several elegant solutions to the collision issue. AIS transmissions can be tracked by multiple concurrent satellites and organized by signal strength to filter overlapping AIS packets. Once the system associates a particular signal/strength to a particular vessel within the grid under review, second and later passes by other satellites provides embellishing data allowing increasing confidence by the system as to each tracked AIS/vessel. As more satellites receive the same AIS, de-collision processing results in a very high level of accuracy regarding signal fidelity.

In addition, the ground based network can post-process the data for select AIS signals after multiple reads from separate constellation satellites. This can be done very rapidly and all de-collisioning accomplished using sophisticated best fit algorithms on large data sets. As the overall processing power of individual satellites increases over time, these will become more articulate in assessing and de-collisioning AIS signals in orbit—and near real time. Again, these solutions are largely possible due to the constellation approach coupled with the ground based station network.

### Image Capture

Using the one or more installed camera systems, the satellite constellation network can also provide near real time imagery data over the entire globe. The large constellation provides mission operators with a high degree of flexibility in how images are captured. For example, to increase the frequency of image update, many satellites may be instructed to capture and transmit images of the same area as their orbits take them within capture range. To increase coverage, the satellites may be instead instructed to capture images of all areas. All captured images can then be compiled to produce a live global map.

Images may be geolocated using the location and orientation data of the satellite. Multiple images and data can be compared and error corrected to increase geolocation accuracy. In one embodiment, image recognition algorithms are used to identify landmark features in captured images to further enhance the geolocation accuracy.

Imaging and AIS reception tasks can be accomplished by the same satellite or shared between more than one satellite.

Image recognition algorithms may be applied to the captured images to identify ships and other objects in the observed area. The geolocation of the identified ships and objects can then be determined using the image geolocation data. Multiple geolocation determinations can be used to correct for error and increase accuracy. This accuracy can be improved, in an example, if the constellation satellites also carry GPS receivers. Knowing the exact time in the orbit and the location and orientation of the satellite, and thus the location of the image, helps with points of reference between the image and AIS data sets.

Successive images may be captured with corresponding image and ship/object location determinations. In one embodiment, information on the speed and heading of a ship or object is derived from the changes in the determined locations of the ship or object between images. Using this method, any changes in the shape and size of an object can also be derived. This may be useful for observing natural phenomena, such as the recession of the polar ice caps or the movement of glaciers. It may also allow for the detection and tracking of oil spills.

### Comparisons Between Data

Data from AIS messages received by the satellite system can be compared to data derived from the captured images. In one embodiment, the location information provided by ships in an observed area is compared to the geolocation determinations for all identified ships in the same area. In another embodiment, additional information provided by ships, such as speed, heading, ship size, ship type, are compared with the same types of data determined from the captured images.

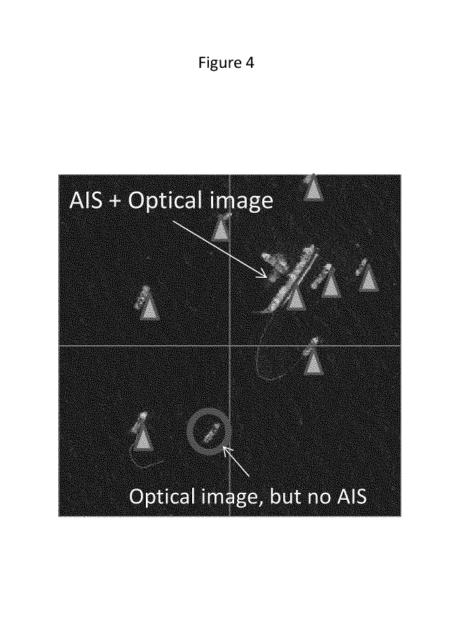

Comparing the AIS and image data also can provide information regarding vessels lacking or deliberately disabling their AIS beacon. Typically vessels will turn off or disable their AIS beacon if they are being used for illegal purposes. Pirates typically do not have or emit AIS data to avoid detection as they operate in their area of influence. FIG. 4 illustrates 9 ships in a review grid. Eight vessels are identified by their AIS data, and that is represented in this image by the triangular marker. However, image data reveals that there are nine vessels in the grid. The comparison matches the AIS data to image data to determine the one vessel not transmitting AIS data. This vessel is likely engaged in legally questionable activities and both the surrounding vessels and/or authorities in the area can be notified.

In some recent examples, Iranian oil tankers were ordered to switch off their AIS transponders by their government to order to make oil shipments counter to certain sanctions imposed against the country. A North Korean freighter was attempting to smuggle weapons into the country, and it had its AIS beacon turned off. The above vessels are tracked or captured by other means, but the present invention can simplify the process, altering authorities almost as soon as the vessels enter international waters.

Piracy is also an issue, with pirates from certain African nations hijacking freighters, tankers, and even cruse ships. Pirates do not use AIS beacons but can then be readily identified using the image comparison. Given that certain geographical areas are more prone to piracy, additional or expanded coverage by the constellation can be warranted. In line with piracy, the poaching of fishing zones is also an issue. Illegal fishing boats will also turn off their AIS beacon when entering certain fishing areas to mask their poaching. Again, the comparison of optical and AIS data can identify these illegal actors.

Turning to determining the differences between the AIS data and image data, the geolocation data derived from the captured images will not have perfect accuracy. Some tolerance must be incorporated to account for error. Thus, the system receives the AIS data from a vessel and begins to de-collision the signal to identify the individual vessels in the grid. The image data is also processed, either on the same satellite or on other constellation satellites. As noted, the geolocation of the vessels in the image are generated and compared to the AIS data. Factors to be considered for the comparison are the location, speed and heading of each vessel as well as the relative size of the vessel, all of which can be determined from both sets of data.

### Other Features

Processing tasks may be shared between satellites and ground servers for more efficient use of system resources.

A large constellation of satellites provides a ship tracking system with comprehensive coverage as well as the capability for duplicative coverage by more than one constellation satellite of a given area at the same time. An embodiment that leverages this capability captures images of an area from multiple angles (i.e. from multiple satellites aimed at the same area) and combines these to form a multi-dimensional view of the space that enhances the image-based ship detection abilities of the system. In another embodiment, images are taken from the same area from the same angle by one or more satellites. Using resolution enhancement, or “super resolution” algorithms, relatively low resolution images can be combined to produce a high resolution image thereby improving the ship image recognition accuracy. The use of lower resolution images also reduces the bandwidth required to transmit the image data through the satellite constellation network and to the ground station. It also allows for the use of lower cost camera sensors.

The AIS tracking satellite system may also be adapted for tracking Automatic dependent surveillance-broadcast (ADS-B) signals transmitted by aircraft. ADS-B makes an aircraft visible in realtime by transmitting position and velocity data every second. The system relies on two components—a high-integrity GPS navigation source and a datalink (ADS-B unit). ADS-B data links can operate at 1090 MHz or at 978 MHz. Again, while the aircraft are over international waters they are typically outside the range of land based receivers. However, the constellation satellites cover a majority of the Earth's surface and can constantly monitor aircrafts from take-off until landing wherever they fly.

Trains can also be monitored. Currently, rail cars may be equipped with radio frequency identification (RFID) tags such as Automatic Equipment Identification (AEI) tags that can be read by a tag reader positioned at known locations within the rail system and configured to recognize and report when an AEI tagged railcar passes. Accordingly, a location and a time of passage of the rail car can be reported to track the last reported locations of the tagged rail cars. Other sensors can be used to transmit data regarding the condition of the train cars, including an accelerometer for detecting movement of the rail car, a temperature sensor, a pressure sensor, a door position sensor, a cargo identification sensor, and a cargo seal condition sensor.

However, prior art AEI system can only provide location information of the rail car at the time when the car passes the reader. At any other position, the exact location of the car is unknown. In addition, another issue with AEI tagged cars is power to the transmitters. The transmitters are typically battery powered, or powered by the reading station. This limits their transmission time and length of information transmitted.

Instead, with the constellation satellites, the train cars can be monitored in real time. The constellation satellites can receive the intermittent messages sent by the transmitters as they pass reading stations. However, the train cars can be further tracked using the image data while the cars are between reading stations. Since the rail lines have defined paths, correlation between the AEI data and the image data can be performed faster, as it is unlikely other trains are present on the same tracks within specified distances. In addition, images from the constellation satellites can monitor activity on the rail tracks and determine if an object is stationary on the tracks for an extended period of time, separating it from typical vehicle and person traffic. If a stationary object is detected on the tracks, information can be passed to the train crew or dispatcher to slow the train to avoid collisions.

Additional advantages can be in the reading stations. Currently they need to be linked to a system to power, read and transmit the AEI data. However, if the constellation satellites are reading the AEI data, the reading stations can be made “dumber” and are then only required to power the AEI tag. Thus the AEI stations can be made less expensively and positioned in areas where there is power, but low data transmission access.

Also note that the technology behind the train car tracking is also the technology supporting most automated road toll collection systems. The present invention can be expanded to also track commercial vehicles with toll collection devices or other transponder technologies. Thus, the present invention can be used to literally track goods or containers from their source to their destination regardless if the goods are shipped via truck, rail, ship, or air.

Further examples are also described below, based on the above examples. One example is system for tracking vehicles wherein each vehicle transmits an identifying signal. As noted above, that signal can be an Automatic Identification System (AIS) signal, an Automatic Dependent Surveillance-Broadcast (ADS-B) signal or an Automatic Equipment Identification (AEI) signal. The system can include a first transmission link to the constellation of low earth orbit satellites. As noted, each satellite can be equipped with a radio receiver tuned to select transmission frequencies associated with the signals of the vehicles. The frequencies of the AIS, ADS-B, and AEI signals are known in the art. A second transmission link to a network of ground stations can be included. The ground stations can be in communication with one or more constellation satellites, see FIG. 3. The second transmission link can deliver data collected by the satellites regarding the vehicle transmissions.

A computer processor at either the ground stations, or on board one or more of the constellation satellites receives input from at least one of first and second transmission links. The processor is programmed to acquire and track vehicle position in near real time based on identifying signals transmitted by said vehicle. Further, it resolves collisions (i.e. de-collisions) between multiple sampled signals based on multiple receiver inputs. There is also an output device to deliver tracking data and warnings relating thereto to one or more system administrators or vessel operators.

The constellation satellites can include an image capture device taking image data of a region associated with the vehicles (e.g. an ocean grid). See, FIG. 4. The image data can be processed by the processor to determine one or more vehicles from the image data (e.g. locate the ships on the open water) and that can be correlated with the identifying signals to determine each vehicle in the image with their respective signals. This process can assist in identifying rogue vehicles, which are vehicles determined in the image data but do not have a respective identifying signal. See, FIG. 4.

In an example for tracking ocean vessels, there can be a data link to the constellation of low earth orbit satellites that collect the data of AIS transmissions for select vessels within defined grid coordinates. That data link or a separate data link to the constellation of low earth orbit satellites can collect image data for the grid corresponding to the AIS data. A computer processor can implement a tracking algorithm that applies the AIS data and the image data to develop a tracking model for ships associated with said AIS data within the grid and ships identified by image data within the grid. It can then have an output system reporting on anomalies between image and AIS data, including warning signals for vessels lacking AIS data.

The computer processor further implements the tracking algorithm to identify rogue ships, which are the ships identified by the image data but are lacking AIS data.

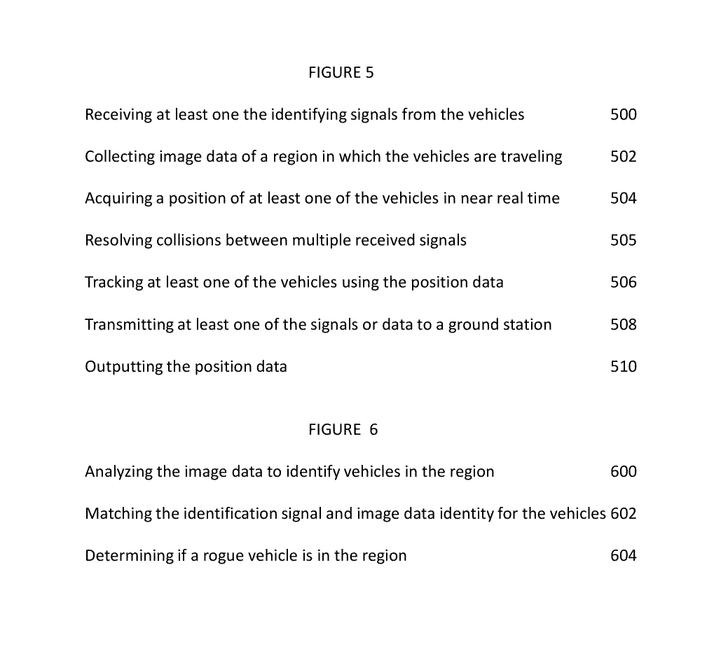

An example of a method to tracking vehicles that emit an identifying signal is illustrated in FIG. 5. Here, the system receives, by at least one of a constellation of low earth orbit satellites, at least one the identifying signals from the vehicles (Step 500). The constellation of low earth orbit satellites also collect image data of a region in which the vehicles are traveling (Step 502). A position of at least one of the vehicles can be acquired in near real time based on the identifying signals transmitted by the vehicle (Step 504) and tracking at least one of the vehicles using the position data (Step 506). At least one of the identifying signals, the image data, or the position data, is transmitted to at least one ground station (Step 508). The ground station can then output at least the position data to an operator of the vehicle and/or a system administrator (Step 510). In a yet further example, the acquiring step can also resolve collisions between multiple received signals from multiple vehicles (Step 505).

Another example of the method is illustrated in FIG. 6 and can include steps of analyzing the image data to identify a majority of the vehicles in the region. (Step 600). Then matching the identification signal and image data identity for a majority of the vehicles in the region (Step 602). This can allow for determining if a rogue vehicle is in the region by identifying vehicles in the image data that do not have the identification signal (Step 604).

As noted above, the identifying signal can be one of an Automatic Identification System (AIS) signal, an Automatic Dependent Surveillance-Broadcast (ADS-B) signal or an Automatic Equipment Identification (AEI) signal, or any other transponder type signal.

Certain implementations of the disclosed technology are described above with reference to block and flow diagrams of systems and methods and/or computer program products according to example implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

Implementations of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claim is:

1. A system for tracking vehicles wherein each vehicle transmits an identifying signal, the system comprising:
a. a first transmission link to a constellation of low earth orbit satellites, wherein each satellite is equipped with a radio receiver tuned to select transmission frequencies associated with the signals of said vehicles;
b. a second transmission link to a network of separately located ground stations in communication with said constellation of satellites wherein the transmission link delivers data collected from said vehicle transmissions;
c. a computer processor receiving input from said first and second transmission links and programmed to:
acquire and track vehicle position in near real time based on identifying signals transmitted by said vehicle; and
resolve collisions between multiple sampled signals based on multiple receiver inputs; and
d. an output device to deliver tracking data and warnings relating thereto to one or more system administrators.

2. The system of claim 1, further comprising:
an image capture device equipped on one or more of the satellites taking image data of a region associated with said vehicles;
wherein the image data is transmitted over the second transmission link;
wherein the computer processor is further programmed to:
determine one or more of said vehicles from the image data; and
correlating the one or more of said vehicles with their respective identifying signals.

3. The system of claim 2, wherein the computer processor is further programmed to identify rogue vehicles, which are vehicles determined in the image data but do not have a respective identifying signal.

4. The system of claim 1, wherein the identifying signal is at least one of an Automatic Identification System (AIS) signal, an Automatic Dependent Surveillance-Broadcast (ADS-B) signal or an Automatic Equipment Identification (AEI) signal.

5. The system of claim 1, wherein the output device deliver tracking data and warnings relating thereto to operators of one or more of said vehicles.

6. A system for tracking ocean vessels comprising
a. a data link to a constellation of low earth orbit satellites collecting data of AIS transmissions for select vessels within defined grid coordinates;
b. a data link to a constellation of low earth orbit satellites collecting image data for said grid corresponding to said AIS data;
c. a computer processor implementing a tracking algorithm that applies said AIS data and said image data to develop a tracking model for vessels associated with said AIS data within the grid and vessels identified by said image data within the grid; and
d. an output system reporting on anomalies between image and AIS data, including warning signals for vessels lacking AIS data.

7. The system of claim 6, wherein the computer processor further implements the tracking algorithm to identify rogue ships, which are vessels identified by the image data but are lacking AIS data.

8. A method of tracking vehicles emitting an identifying signal, comprising the steps of:
receiving by at least one of a constellation of low earth orbit satellites, at least one the identifying signals from the vehicles;
collecting image data of a region in which the vehicles are traveling by at least one of the constellation of low earth orbit satellites;
acquiring a position of at least one of the vehicles in near real time based on the identifying signals transmitted by the vehicle and tracking at least one of the vehicles using the position data;
transmitting at least one of the identifying signals, the image data, or the position data, to at least one of a network of separately located ground stations in communication with said constellation of satellites; and
outputting, by a ground station, at least the position data to at least one of an operator of the vehicle or a system administrator.

9. The method of claim 8, wherein the acquiring step further comprises the step of resolving collisions between multiple received signals from multiple vehicles.

10. The method of claim 8, further comprising the steps of:
analyzing the image data to identify a majority of the vehicles in the region;
matching the identification signal and image data identity for a majority of the vehicles in the region; and
determining if a rogue vehicle is in the region by identifying vehicles in the image data that do not have the identification signal.

11. The method of claim 8, wherein the identifying signal is at least one of an Automatic Identification System (AIS) signal, an Automatic Dependent Surveillance-Broadcast (ADS-B) signal or an Automatic Equipment Identification (AEI) signal.
